(19) United States
(12) Patent Application Publication
(10) Pub. No.: US 2008/0213670 A1
(43) Pub. Date: Sep. 4, 2008

(54) NON-AQUEOUS ELECTROLYTE SECONDARY BATTERY

(76) Inventors: Yukihiro OKADA, Osaka (JP); Hideaki Fujita, Osaka (JP)

Correspondence Address: MCDERMOTT WILL & EMERY LLP, 600 13TH STREET, NW, WASHINGTON, DC, 20005-3096, US

(21) Appl. No.: 12/039,579

(22) Filed: Feb. 28, 2008

(30) Foreign Application Priority Data
Mar. 2, 2007 (JP) 2007-052336

(51) Int. Cl. H01M 4/40; H01M 2/14

(52) U.S. Cl. 429/231.95; 429/246

(57) ABSTRACT

In a non-aqueous electrolyte secondary battery including an electrode assembly including a positive electrode containing a positive electrode active material, a negative electrode containing a negative electrode active material, and a separator interposed therebetween; and a non-aqueous electrolyte, 80 wt % or more of the positive electrode active material is primary particles, and the separator is formed by a porous film, or the porous film is formed at at least one position from the following: between the positive electrode and the separator main body, between the negative electrode and the separator main body, and inside the separator main body, to capture the metal ions leached from the positive electrode active material. Such an arrangement enables a non-aqueous electrolyte secondary battery with significantly less decline in battery capacity, excellent charge and discharge cycle life performance, and capable of stable output for a longer period of time.

### FIELD OF THE INVENTION

The present invention relates to non-aqueous electrolyte secondary batteries. To be more specific, the present invention mainly relates to improvement in a positive electrode active material.

### BACKGROUND OF THE INVENTION

Nowadays, electronic devices, especially small consumer electronic devices are increasingly becoming portable and wireless at a fast pace, and for power sources for driving these devices, development of small, lightweight, high-energy density, and long-life secondary batteries is strongly desired. In addition to small consumer electronic devices, there has been rapid-pace development of technology for large secondary batteries used for electrical energy storage and electric cars, which require long-term durability and safety. In view of the foregoing, non-aqueous electrolyte secondary batteries, particularly, lithium secondary batteries are expected as a power source for electronic devices, electrical energy storage, and electric cars, due to its high-voltage and high-energy density.

Non-aqueous electrolyte secondary batteries include a positive electrode, a negative electrode, and a separator. The positive electrode is formed of a positive electrode material mixture, which contains a positive electrode active material, a conductive agent, and a binder. For the positive electrode active material, for example, a transition metal oxide having a higher potential relative to lithium and excellently safe is used. Further specifically, mainly used are composite transition metal oxides which are formed of transition metal oxides such as LiCoO₂ and LiNiO₂ in which the transition metal thereof is in part replaced with Mn, Al, Co, Ni, or Mg. The negative electrode contains a negative electrode active material, which includes various carbon materials such as graphite. The separator is disposed between the positive electrode and the negative electrode, and is impregnated with a non-aqueous electrolyte. For the separator, mainly, a polyolefin-made microporous film is used. For the non-aqueous electrolyte, for example, a non-aqueous electrolyte made by dissolving a lithium salt such as LiBF₄ and LiPF₆ in an aprotic organic solvent is used.

In non-aqueous electrolyte secondary batteries, a powder composite transition metal oxide is used as the positive electrode active material. The powder is secondary particles formed of aggregations of fine primary particles. In non-aqueous electrolyte secondary batteries with an electrolyte containing Li ions, that is, in lithium ion batteries, by insertion and removal of Li into and from the positive electrode active material while charging and discharging, the primary particles of the positive electrode active material repeat expansion and contraction. Thus, the repetitive charge and discharge cycles cause the primary particles to expand and contract, which adds stresses to the grain boundary of primary particles, leading to the disintegration of the secondary particles. Although the primary particles at the surface of the disintegrated secondary particles contribute to charge and discharge reactions since its contact with the conductive agent secures the electrical connection, the primary particles that are present inside the disintegrated secondary particle are disconnected from the contact with the surface-side primary particles by the disintegration, and are not in contact with the conductive agent either: therefore, the primary particles that are present inside the disintegrated secondary particle achieve no electrical contact, and contribute to no charge and discharge reaction. Thus, with repetitive charge and discharge cycles, battery capacity declines to the degree of the primary particle that is present inside the disintegrated secondary particles.

To prevent the decline in battery capacity, for example, Japanese Laid-Open Patent Publication No. 2003-68300 has proposed a material for positive electrode active materials used in lithium secondary batteries. The material is composed of a lithium-containing composite transition metal oxide powder having a basic composition of LiMeO₂ (Me represents a transition metal), and its powder particles are present mostly in primary particle form, without forming secondary particles. According to this publication document, since the secondary particles with grain boundary barely exist, the capacity decline due to the disintegration (micronization) of secondary particles does not occur even with expansion and contraction of primary particles while charging and discharging, and battery charge and discharge cycle life performance improves. However, by merely using the primary particles for positive electrode active materials as is proposed by this publication document, decline in battery capacity cannot be prevented and the improvement effects on charge and discharge cycle life performance are insufficient.

### BRIEF SUMMARY OF THE INVENTION

The present invention aims to provide a non-aqueous electrolyte secondary battery which is excellent in charge and discharge cycle life performance and in which capacity decline is prevented even with repetitive charge and discharge cycles.

The inventors of the present invention focused on the technique of the above publication document in the process of the research for solving the above problem. Conventional non-aqueous electrolyte secondary batteries generally use secondary particles formed of the aggregation of primary particles in the positive electrode active material. The primary particles of the positive electrode active material repeat expansion and contraction with charge and discharge cycles, which generates a grain boundary stress between the primary particles. The grain boundary stress soon causes the disintegration of the secondary particles. Among the primary particles generated by such disintegration, the primary particles that are present inside the secondary particle are disconnected from contact with the primary particles at the secondary particle surface. Also, the primary particles that are present inside the secondary particles have almost no contact with the conductive agent.

The disintegration of the secondary particles generates primary particles that have insufficient electrical contact and are unable to contribute to charge and discharge reaction. Battery capacity declines to the degree of the presence of such primary particles. Therefore, it can be assumed that by allowing the primary particles to be present in dispersed state as the positive electrode active material, the decline in battery capacity due to the disintegration of the secondary particles with charge and discharge cycles can be curbed. However, inventors of the present invention found out in their research that decline in battery capacity cannot be curbed sufficiently and charge and discharge cycle life performance cannot be improved to the point of satisfaction just by using the primary particles of the positive electrode active material.

Inventors of the present invention speculated that causes for failing to curb the decline in battery capacity reside in increase in the specific surface area of the positive electrode active material involved with use of the primary particles. During storage or in charge and discharge cycle, ions of metals such as cobalt and manganese are leached out from the positive electrode active material into the non-aqueous electrolyte. It is assumed that the metal ions are precipitated and deposited on the negative electrode active material surface, which inhibit the negative electrode active material to be active. The increase in the specific surface area of the positive electrode active material naturally leads to an increase in the amount of metal ions that are leached out from the positive electrode active material and also its amount deposited to the negative electrode active material surface. Thus, the decline in battery capacity becomes notable.

Inventors of the present invention further pursued research based on such findings. As a result, the inventors of the present invention achieved obtaining a non-aqueous electrolyte secondary battery which has excellent charge and discharge cycle life performance and which achieves curbing capacity decline due to the disintegration of the positive electrode active material and due to metal ions leached out from the positive electrode active material without impairing performance other than battery capacity, by using a positive electrode active material in a dispersed state as primary particles, and by providing a porous film at a specific portion of the non-aqueous electrolyte secondary battery, thereby completing the present invention.

That is, the present invention provides a non-aqueous electrolyte secondary battery comprising:

an electrode assembly comprising
a positive electrode containing a positive electrode active material capable of absorbing and desorbing lithium ions,
a negative electrode containing a negative electrode active material capable of absorbing and desorbing lithium ions, and
a separator interposed therebetween; and

a non-aqueous electrolyte retained by the electrode assembly,

wherein 80 wt % or more of the positive electrode active material is primary particles, and

at least a portion of the separator comprises a porous film.

The separator may entirely be the porous film, or the porous film may be provided at at least one selected from the group consisting of: between the positive electrode and the separator main body, between the negative electrode and the separator main body, and inside the separator main body.

The porous film preferably contains metal oxide particles.

The metal oxide particles are preferably at least one selected from the group consisting of magnesium oxide, aluminum oxide, and zirconium oxide.

The average particle size of the primary particles is preferably 0.1 to 10 μm.

The average particle size of the primary particles is further preferably 0.1 to 3 μm.

The positive electrode active material is preferably a lithium-containing composite metal oxide represented by the general formula:

LiₓCo_{y}M_{1-y}O_{z}

where M is at least one element selected from the group consisting of Na, Mg, Sc, Y, Mn, Fe, Co, Ni, Cu, Zn, Al, Cr, Pb, Sb, and B; and x=0 to 1.2, y=0 to 0.9, and z=2.0 to 2.3.

A non-aqueous electrolyte secondary battery of the present invention is characterized in that

80 wt % or more of the positive electrode active material is dispersed in the positive electrode as primary particles; and,

the separator is formed by a porous film in its entirety, or a porous film is provided at at least one selected from the group consisting of: between the positive electrode and the separator main body; between the negative electrode and the separator main body; and inside the separator main body.

By using the positive electrode active material in dispersed state as primary particles, the secondary particles with grain boundary are not be present, and therefore even though the primary particles are expanded and contracted during charge and discharge cycles, electrically non-conductive primary particles will not be generated. Thus, decline in battery capacity involved with charge and discharge cycles is minimized. Additionally, by providing a porous film at a specific portion, even though the primary particle positive electrode active material is used, the metal ions leached out from the positive electrode active material surface are captured by the porous film by priority, and therefore the metal ion attachment (precipitation) and deposition to the negative electrode active material surface can be curbed, and thus the decline in battery capacity is prevented. These effects are notable when using 80 wt % or more of the positive electrode active material dispersed as primary particles. Therefore, in a non-aqueous electrolyte secondary battery of the present invention, capacity decline is excellently curbed even with repetitive charge and discharge cycles; charge and discharge cycle life performance is excellent; and life is longer compared with conventional non-aqueous electrolyte secondary batteries.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a scanning electron micrograph of primary particles of a positive electrode active material used in the present invention.

FIG. 2 is a scanning electron micrograph of the secondary particles of the conventionally used positive electrode active material.

FIG. 3 is a graph illustrating cycle life performance of a cylindrical battery made in Example.

FIG. 4 is a graph illustrating cycle life performance of a cylindrical battery made in Example.

### DETAILED DESCRIPTION OF THE INVENTION

A non-aqueous electrolyte secondary battery of the present invention is characterized in that: (1) 80 wt % or more of the positive electrode active material capable of absorbing and desorbing lithium ions is primary particles; and (2) at least a portion of the separator comprises a porous film. Other than (1) and (2), the non-aqueous electrolyte secondary battery is formed similarly to conventional non-aqueous electrolyte secondary batteries.

Further specifically, the non-aqueous electrolyte secondary battery of the present invention includes:

an electrode assembly including
a positive electrode containing a positive electrode active material capable of absorbing and desorbing lithium ions,
a negative electrode containing a negative electrode active material capable of absorbing and desorbing lithium ions, and
a separator interposed therebetween; and

a non-aqueous electrolyte retained by the electrode assembly,

wherein characteristics (1) and (2) above are included.

The positive electrode is provided to face the negative electrode with the separator interposed therebetween, and includes, for example, a positive electrode current collector and a positive electrode active material layer. In this case, the positive electrode is disposed so that the positive electrode active material layer faces the separator.

For the positive electrode current collector, those used in this field may be used: for example, a porous or non-porous conductive substrate of a metal material such as stainless steel, titanium, and aluminum may be mentioned. The form of the positive electrode current collector may not be limited particularly: for example, a sheet-like, a film-like, and a plate-like one may be mentioned. The form may be appropriately selected from these, according to the form and application of the non-aqueous electrolyte secondary battery itself to be obtained. When the positive electrode current collector has a sheet-like, a film-like, or a plate-like form, although its thickness is not particularly limited, it is preferably 1 to 50 μm, and further preferably 5 to 20 μm. By setting the thickness to the above range, the mechanical strength of the positive electrode current collector and the non-aqueous electrolyte secondary battery is kept while achieving lightweight.

The positive electrode active material layer contains a positive electrode active material capable of absorbing and desorbing lithium ions. In the positive electrode active material, 80 wt % or more, preferably 95 wt % or more is primary particles. The primary particles are present in a dispersed state in the positive electrode active material layer. When the proportion of the primary particles in the positive electrode active material is below 80 wt %, the proportion of the secondary particles increases, and decline in battery capacity involved with charge and discharge cycle becomes notable.

When making comparison between battery (1) including a positive electrode active material of 100 wt % primary particles, and battery (2) including a positive electrode active material of 80 wt % primary particles and the remaining wt % of the secondary particles, the battery capacity of battery (2) only declines to the percentage of about 1 to 2% after charge and discharge cycles compared with the battery capacity of battery (1). Additionally, after charge and discharge cycles, decline in battery capacity in battery (2) is low in degree compared with decline in battery capacity in conventional batteries. Therefore, by using the positive electrode active material with 80 wt % or more of the primary particles, a battery excellent in charge and discharge cycle performance more than conventionally achieved can be obtained.

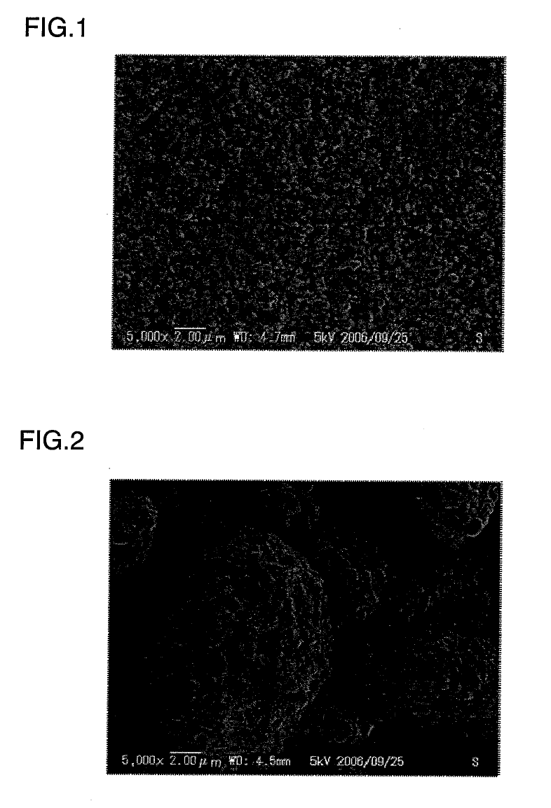

FIG. 1 is a scanning electron micrograph of an example of primary particles of the positive electrode active material used in the present invention. FIG. 2 is a scanning electron micrograph of the secondary particles of the positive electrode active material used in conventional technique. In the present invention, the primary particles are, as shown in FIG. 1, stand-alone particles without forming secondary particles by aggregation and bond of particles.

On the other hand, secondary particles are, as shown in FIG. 2, the particles formed by aggregation and bond of many primary particles. In secondary particles, primary particles are bound together by relatively strong bonding strength. In the primary particles of the positive electrode active material used in the present invention, a slight amount of aggregates of the primary particles generated inevitably due to manufacturing processes may be included. Aggregates are, unlike secondary particles, formed by relatively weak bond between primary particles, and mostly easily separate into primary particles with an application of a small stress. Therefore, even though a slight amount of aggregates is included in the primary particles, decline in battery capacity is not expected.

The average particle size of the primary particles of the positive electrode active material is preferably 0.1 to 10 μm, further preferably 0.1 to 3 μm, and still further preferably 0.3 to 2 μm. With the primary particles having the average particle size of below 0.1 μm, packing density of the positive electrode active material in the positive electrode active material layer cannot be increased to the degree of satisfaction, and the capacity density of the non-aqueous electrolyte secondary battery to be obtained may be insufficient. With the primary particles having the average particle size of more 10 μm, output performance of the positive electrode active material may be low. In this specification, the average particle size of the primary particles is based on the volume average particle size measured with laser diffraction/scattering method (microtrac) by using laser diffraction particle size distribution analyzer (product name: MT3000, manufactured by Nikkiso Co., Ltd.). The proportion of the primary particle content in the positive electrode active material is also measured by using laser diffraction particle size distribution analyzer (MT3000).

The primary particles of the positive electrode active material to be used in the present invention may be made by a known method or a combination of known methods, such as solid reaction method, precipitation method, molten salt method, spray combustion method, and crushing method. In the solid reaction method, primary particles are obtained by mixing raw material powders and baking the mixture. In the precipitation method, primary particles are precipitated in a solution. In the crushing method, primary particles are obtained by applying a mechanical stress to secondary particles. The mechanical stress is applied by, for example, a dry or wet ball mill, a vibration mill, or a jet mill. To be more specific, secondary particles are crushed to primary particles by, for example, crushing the secondary particles of the positive electrode active material under the presence of a medium such as zirconia beads using a planetary ball mill.

Although the positive electrode active material to be used in the present invention is not particularly limited as long as it can absorb and desorb lithium ions and can be made into primary particles, a lithium-containing composite metal oxide is preferably used. A lithium-containing composite metal oxide is a metal oxide containing lithium and a transition metal, with or without a different element replacing a portion of the transition metal therein. The different element includes, for example, Na, Mg, Sc, Y, Mn, Fe, Co, Ni, Cu, Zn, Al, Cr, Pb, Sb, and B. In these elements, Mn, Al, Co, Ni, and Mg are preferable. The different element may be used singly, or may be used in combination of two or more.

Specific examples of the lithium-containing composite metal oxide include, for example, LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂MPO₄F (where M is at least one element selected from the group consisting of Na, Mg, Sc, Y, Mn, Fe, Co, Ni, Cu, Zn, Al, Cr, Pb, Sb, and B; and x=0 to 1.2, y=0 to 0.9, and z=2.0 to 2.3). The value of x representing the molar ratio of lithium is the value immediately after the production of the positive electrode active material, and increases or decreases based on charge and discharge. In these examples, the lithium-containing composite metal oxide represented by the general formula LiₓCo_{y}M_{1-y}O₂ (where M, x, y, and z are the same as above) is preferable.

The lithium-containing composite metal oxide may be made with a known method. For example, secondary particles of the lithium-containing composite metal oxide can be obtained by preparing a composite metal hydroxide containing a metal other than lithium with a coprecipitation method using an alkaline such as sodium hydroxide; obtaining a composite metal oxide by heat-treating the composite metal hydroxide; and further heat-treating the composite metal oxide with a lithium compound such as lithium hydroxide added. By crushing this lithium-containing composite metal oxide with the crushing method, primary particles of the lithium-containing composite metal oxide used in the present invention are obtained.

The positive electrode active material may be used singly, or may be used in combination of two or more. The positive electrode active material surface may be treated with metal oxides, lithium oxides, and conductive agents; and the positive electrode active material surface may also be treated to give hydrophobicity.

The positive electrode may be made, for example, by applying a positive electrode material mixture slurry containing primary particles of the positive electrode active material on the positive electrode current collector surface, and drying the slurry to form the positive electrode active material layer. The positive electrode material mixture slurry contains, for example, a conductive agent, a binder, and an organic solvent in addition to the positive electrode active material.

For the conductive agent, those used in the art may be used: for example, graphites such as natural graphite and artificial graphite; carbon blacks such as acetylene black, ketjen black, channel black, furnace black, lamp black, and thermal black; conductive fibers such as carbon fiber and metal fiber; carbon fluoride; powder of metal such as aluminum; conductive whiskers such as zinc oxide and potassium titanate; a conductive metal oxide such as titanium oxide; and an organic conductive material such as phenylene derivative may be mentioned. The conductive agent may be used singly, or may be used in combination of two or more as necessary.

As the binder, those used in the art may be used: for example, polyvinylidene fluoride (PVDF), polytetrafluoroethylene, polyethylene, polypropylene, aramid resin, polyamide, polyimide, polyamide-imide, polyacrylnitrile, polyacrylic acid, polymethyl acrylate ester, polyethyl acrylate ester, polyhexyl acrylate ester, polymethacrylic acid, polymethyl methacrylate ester, polyethyl methacrylate ester, polyhexyl methacrylate ester, polyvinyl acetate, polyvinylpyrrolidone, polyether, polyether sulfone, hexafluoropolypropylene, styrenebutadiene rubber, and carboxymethyl cellulose may be mentioned. A copolymer of two or more monomer compound selected from the group consisting of the following may be used as well: tetrafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene. The binder may be used singly, or may be used in combination of two or more as necessary.

For the organic solvent as well, those used in the art may be used: for example, dimethylformamide, dimethylacetamide, methylformamide, N-methyl-2-pyrrolidone (NMP), dimethyl amine, acetone, and cyclohexanone may be mentioned.

The positive electrode material mixture slurry may be prepared, for example, by dissolving or dispersing a positive electrode active material, a conductive agent, and a binder in an organic solvent. When the positive electrode material mixture slurry includes a positive electrode active material, a conductive agent, and a binder as its solid content, preferably, the proportion of the positive electrode active material relative to the total amount of the solid content is 80 to 97 wt %, the proportion of the conductive agent relative to the total amount of the solid content is 1 to 20 wt %, and the proportion of the binder relative to the total amount of the solid content is 1 to 10 wt %. The amount of the three components may be selected appropriately from the respective range so that the total content becomes 100 wt %.

The negative electrode is provided to face the positive electrode with the separator interposed therebetween, and includes, for example, a negative electrode current collector and a negative electrode active material layer. In this case, the negative electrode is provided so that the negative electrode active material layer faces the separator.

For the negative electrode current collector, those used in the art may be used: for example, a porous or non-porous conductive substrate of a metal material such as stainless steel, nickel, copper, and copper alloy may be mentioned. The form of the negative electrode current collector may not be limited particularly, and for example, a sheet-like, a film-like, and a plate-like one may be mentioned. The form may be appropriately selected from these, according to the form and application of the non-aqueous electrolyte secondary battery itself to be obtained. When the negative electrode current collector is a sheet-like, a film-like, or a plate-like form, although its thickness is not particularly limited, it is preferably 1 to 50 μm, and further preferably 5 to 20 μm. By setting the thickness to the above range, the mechanical strength of the negative electrode current collector and the non-aqueous electrolyte secondary battery is kept while achieving lightweight.

The negative electrode active material layer contains a negative electrode active material capable of absorbing and desorbing lithium ions, and is provided at the negative electrode current collector surface. For the negative electrode active material, those used in the art may be used: for example, metal, metal fiber, carbon material, oxide, nitride, silicon, silicon compound, tin, tin compound, and various alloy materials may be.mentioned. In these examples, in view of high capacity density, carbon material, silicon, silicon compound, tin, and tin compound are preferable. For the carbon material, for example, various natural graphites, coke, partially graphitized carbon, carbon fiber, spherical carbon, various artificial graphites, and amorphous carbon may be mentioned. For the silicon compound, for example, silicon-containing alloy, silicon-containing inorganic compound, silicon-containing organic compound, and solid solution may be mentioned. Specific examples of the silicon compound include, for example, a silicon oxide represented by SiOₐ (0.05<a<1.95); an alloy containing silicon and at least one element selected from the group consisting of Fe, Co, Sb, Bi, Pb, Ni, Cu, Zn, Ge, In, Sn, and Ti; a silicon compound or silicon-containing alloy in which silicon contained in silicon, silicon oxide or alloy is partially replaced with at least one element selected from the group consisting of B, Mg, Ni, Ti, Mo, Co, Ca, Cr, Cu, Fe, Mn, Nb, Ta, V, W, Zn, C, N, and Sn; and a solid solution thereof may be mentioned. For the tin compound, for example, SnOb (0<b<2), SnO₂, SnSiO₃, Ni₂Sn₄, and Mg₂Sn may be mentioned. The negative electrode active material may be used singly, or may be used in combination of two or more as necessary.

The negative electrode may be made, for example, by applying a negative electrode material mixture slurry containing a negative electrode active material on the negative electrode current collector, and drying to form the negative electrode active material layer. The negative electrode material mixture slurry contains, for example, a negative electrode active material, a binder, and an organic solvent. The binder and the organic solvent may be appropriately selected from the binder and the organic solvent used to prepare the positive electrode material mixture slurry. The negative electrode material mixture slurry may be made, for example, by dissolving or dispersing the negative electrode active material and binder in an organic solvent. When the negative electrode material mixture slurry contains the negative electrode active material and the binder as its solid content, preferably, the proportion of the negative electrode active material relative to the total amount of the solid content is 90 to 99.5 wt %, and the proportion of the binder relative to the total amount of the solid content is 0.5 to 10 wt %.

The separator is provided between the positive electrode and the negative electrode. The separator may be entirely formed of the porous film to be described in the following. Usually, the separator includes the porous film at at least a portion thereof, thus including a separator main body and a porous film. For the separator main body, for example, a sheet-like material or film-like material having predetermined ion permeability, mechanical strength, and nonconductivity is used. Specific examples of the separator main body include a porous sheet-like material or film-like material such as microporous film, woven fabric, and nonwoven fabric. The microporous film may be a single-layer film or multi-layer film (composite film). The single-layer film is formed of a type of material. The multi-layer film (composite film) is a stack of the single-layer film formed of a type of material, or a stack of the single-layer films each formed of a different material.

For the material for the separator main body, although various resin materials may be used, in view of durability, shutdown function, and battery safety, polyolefins such as polyethylene and polypropylene are preferably used. The shutdown function is a function to close the through hole upon occurrence of abnormal heat in a battery, which curbs ion permeation and blocks battery reaction. The separator main body may be formed, by stacking two or more layers of for example a microporous film, a woven fabric, and a nonwoven fabric, as necessary. Thickness of the separator is generally 10 to 300 μm, preferably 10 to 40 μm, further preferably 10 to 30 μm, and still further preferably 10 to 25 μm. The porosity of the separator is preferably 30 to 70%, and further preferably 35 to 60%. The porosity is a ratio of the total capacity of pores in the separator relative to the separator volume.

The porous film prevents decline in battery capacity due to precipitation and deposition of metal ions to the negative electrode surface, for example, by capturing metal ions leached from the positive electrode active material. The porous film is characterized in that it contains metal oxide particles. By allowing the porous film to contain the metal oxide particles, the effect of capturing metal ions leached from the positive electrode active material becomes greater. This is probably because the leached metal ions are mostly deposited to the negative electrode surface as oxides, and the metal ions are easily attached and deposited, with the metal oxide particles having similar properties with the deposited substance as core. Even though the metal ions are attached and deposited to the metal oxide particles, with the presence of the metal oxide particles as the porous film, decline in lithium ion permeability is curbed. For the metal oxide particles, for example, aluminum oxide (Al₂O₃, alumina), magnesium oxide (MgO, magnesia), and zirconium oxide may be mentioned. Although the particle size of the metal oxide particles is not particularly limited, it is preferably 0.01 to 1 μm. The metal oxide particles may be used singly, or may be used in combination of two or more as necessary. Although the thickness of the porous film is not particularly limited, it is preferably 2 to 10 μm.

The porous film is provided at at least one selected from the group consisting of the following: between the positive electrode and the separator main body, between the negative electrode and the separator main body, and inside the separator main body. When the porous film is to be provided between the positive electrode and the separator main body, the porous film may be formed at the positive electrode active material layer surface of the positive electrode, or at the separator main body surface facing the positive electrode active material layer. The porous film may be formed at both of the positive electrode and the separator main body. The porous film may also be made separately and disposed between the positive electrode and the separator main body. When the porous film is to be provided between the negative electrode and the separator main body, the porous film may be formed at the negative electrode active material layer surface of the negative electrode, or at the separator main body surface facing the negative electrode active material layer. The porous film may be formed at both of the negative electrode and the separator main body. The porous film may be made separately and disposed between the negative electrode and the separator main body. When the porous film is to be provided inside the separator main body, the separator main body may be made, for example, to have a multi-layer structure and the porous film may be formed at one or both sides of at least one of the microporous film, woven fabric, or nonwoven fabric in the multi-layer. The porous film may also be made separately and disposed at at least one position between the plurality of microporous films, woven fabrics, or nonwoven fabrics forming the multi-layer. Further, when the separator main body is formed of the microporous film, and the microporous film is made of a plurality of single-layer films, the porous film may be formed at one side or both sides of at least one single-layer film. The porous film may be made separately and disposed at at least one position between the single-layer films.

The porous film may be made, for example, by applying a paste containing metal oxide particles on the surface of the positive electrode, the negative electrode, or the separator, and then drying the paste. The paste contains a binder and an organic solvent besides the metal oxide particles. For the binder, for example, PVDF, polyether sulfone, polyvinylpyrrolidone, polyamide, polyimide, and polyamide-imide may be used. For the organic solvent, for example, N-methyl-2-pyrrolidone (NMP) may be used. The paste may be prepared, for example, by dissolving or dispersing the metal oxide particles and the binder in the organic solvent. Although the proportion of the metal oxide particles to the binder is not particularly limited, preferably, the amount of the metal oxide particles is 90 to 99 wt % relative to the total amount of the metal oxide particles and the binder, and the amount of the binder is the remaining percentage.

For the non-aqueous electrolyte, for example, liquid non-aqueous electrolyte, gelled non-aqueous electrolyte, and solid electrolyte (for example, solid polymer electrolyte) may be mentioned.

Liquid non-aqueous electrolyte contains a solute (supporting salt) and a non-aqueous solvent, and further contains various additives as necessary. The solute is usually dissolved in the non-aqueous solvent. In the case of the liquid non-aqueous electrolyte, for example, the electrode assembly is impregnated with the liquid non-aqueous electrolyte.

For the solute, those used in the art may be used: for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, chloroborane lithium, borates, and imide salts may be mentioned. Borates include lithium bis(1,2-benzenedioleate(2-)-O,O′)borates, lithium bis(2,3-naphthalenedioleate(2-)-O,O′)borate, lithium bis(2,2′-biphenyldioleate(2-)-O,O′)borate, and lithium bis(5-fluoro-2-oleate-1-benzenesulfonic acid-O,O′)borate. Imide salts include bistrifluoromethane sulfonic acid imide lithium ((CF₃SO₂)₂NLi), trifluoromethane sulfonic acid nonafluorobutane sulfonic acid imide lithium ((CF₃SO₂) (C₄F₉SO₂)NLi), and bispentafluoroethane sulfonic acid imide lithium ((C₂F₅SO₂)₂NLi). The solute may be used singly, or may be used in combination of two or more. The solute in the range of 0.5 to 2 mol/L is preferably dissolved relative to the non-aqueous solvent.

For the non-aqueous solvent, those used in the art may be used: for example, cyclic carbonate, chain carbonate, and cyclic carboxylate may be mentioned. For the cyclic carbonate, for example, propylene carbonate (PC) and ethylene carbonate (EC) may be mentioned. For the chain carbonate, for example, diethyl carbonate (DEC), ethyl methyl carbonate (EMC), and dimethylcarbonate (DMC) may be mentioned. For the cyclic carboxylate, for example, γ-butyrolactone (GBL) and γ-valerolactone (GVL) may be mentioned. The non-aqueous solvent may be used singly or may be used in combination of two or more as necessary.

For the additive, for example, a material for improving charge and discharge efficiency, and a material for deactivating batteries may be mentioned. The material for improving charge and discharge efficiency improves charge and discharge efficiency by, for example, decomposing itself on the negative electrode to form a coating high in lithium ion conductivity. Specific example of such materials include, for example, vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. These may be used singly, or may be used in combination of two or more. Among these, at least one selected from the group consisting of vinylene carbonate, vinyl ethylene carbonate, and divinyl ethylene carbonate is preferable. In the above compounds, hydrogen atoms may be partially replaced with fluorine atoms.

The material for deactivating the batteries deactivates batteries by, for example, decomposing itself when batteries are overcharged to form a coating on the electrode surface. For such a material, for example, a benzene derivative may be mentioned. For the benzene derivative, a benzene compound including a phenyl group and a cyclic compound group adjacent to the phenyl group may be mentioned. For the cyclic compound group, for example, phenyl group, cyclic ether group, cyclic ester group, cycloalkyl, and phenoxy group are preferable. Specific examples of the benzene derivative include, for example, cyclohexyl benzene, biphenyl, and diphenyl ether may be mentioned. The benzene derivative may be used singly, or may be used in combination of two or more. However, the benzene derivative content in the liquid non-aqueous electrolyte is preferably 10 parts by volume or less relative to 100 parts by volume of the non-aqueous solvent.

The gelled non-aqueous electrolyte contains a liquid non-aqueous electrolyte and a polymer material retaining the liquid non-aqueous electrolyte. The polymer material to be used is for allowing a liquid to gel. For the polymer material, those used in the art may be used: for example, polyvinylidene fluoride, polyacrylonitrile, polyethyleneoxide, polyvinyl chloride, and polyacrylate may be mentioned.

The solid electrolyte contains a solute (supporting salt) and a polymer material. For the solute, the examples shown above may be used. For the polymer material, for example, polyethylene oxide (PEO), polypropylene oxide (PPO), and a copolymer of ethylene oxide and propylene oxide may be mentioned.

A non-aqueous electrolyte secondary battery of the present invention may be manufactured by, for example, winding or stacking the positive electrode containing the positive electrode active material of primary particles, and the negative electrode with the separator interposed therebetween to form the electrode assembly, and then inserting the electrode assembly into a battery case with the non-aqueous electrolyte. In the electrode assembly, the porous film is formed at at least one of the following: between the positive electrode and the separator; between the negative electrode and the separator; and inside the separator.

The non-aqueous electrolyte secondary battery of the present invention is excellent in cycle life performance. Therefore, the non-aqueous electrolyte secondary battery is useful for a power source for electronic devices such as laptop personal computer, mobile phone, personal data assistant, digital still camera, and further a power source for energy storage, and vehicles such as hybrid electric vehicle and electric car, which require a longer life.

In the following, the present invention is described in detail by referring to Examples and Comparative Examples.

### EXAMPLE 1

### (1) Positive Electrode Active Material Preparation

An aqueous solution with a metal ion concentration of 2 mol/L was prepared by adding Co and Al sulfates to a NiSO₄ aqueous solution, so that the molar ratio between Ni, Co, and Al is Ni:Co:Al=7:2:1. A sodium hydroxide solution with a molar concentration of 2 mol/L was gradually dropped to this aqueous solution for neutralization, to produce a ternary precipitate having the composition represented by Ni_{0.7}Co_{0.2}Al_{0.1}(OH)₂ with a coprecipitation method. The precipitate was separated by filtering, washed with water, and dried at a temperature of 80° C., to obtain a composite hydroxide. The average particle size of the obtained composite hydroxide determined by a particle size distribution analyzer (product name: MT3000, manufactured by Nikkiso Co., Ltd.) was 10 μm.

This composite hydroxide was heat-treated in an atmosphere at 900° C. for 10 hours, to obtain a ternary composite oxide having a composition represented by Ni_{0.7}Co_{0. 2}Al_{0.1}O. Lithium hydroxide monohydrate was added so that the number of atoms of Ni, Co, and Al in total and the number of Li atoms are equal, and heat-treatment was carried out in an atmosphere at 800° C. for 10 hours, thereby obtaining a lithium-containing composite metal oxide having a composition represented by LiNi_{0.7}Co_{0.2}Al_{0.1}O₂. As a result of analysis with powder X-ray diffraction, it was confirmed that this lithium-containing composite metal oxide had a single phase, hexagonal structure, and that Co and Al were making a solid solution.

A positive electrode active material having secondary particles with an average particle size of 10 μm and a specific surface area of 0.45 m²/g by the BET method was obtained. As a result of analyzing this positive electrode active material with a scanning electron microscope (SEM), it was found that the particle size of the primary particles forming the secondary particles was about 0.4 μm. After mixing 100 parts by weight of this positive electrode composite oxide and 200 parts by weight of N-methyl-2-pyrrolidone (hereinafter referred to as “NMP”), the mixture was crushed by using zirconia beads with a diameter of 2 mm in a planetary ball mill for two hours. As a result of measuring the particle size distribution, it was determined that the average particle size was 0.4 μm, and as a result of SEM observation, it was confirmed that the secondary particles were crushed into primary particles.

### (2) Positive Electrode Preparation

A positive electrode material mixture slurry was made by mixing 1000 g of the positive electrode active material, 25 g of acetylene black, 400 g of an NMP solution in which 8 wt % of polyvinylidene fluoride (PVDF)(binder) was dissolved, and 700 g of NMP (solvent). This positive electrode material mixture slurry was applied on both sides of Al foil with a thickness of 15 μm (positive electrode current collector), dried, rolled, and cut to give a predetermined size to obtain a positive electrode. FIG. 1 is a scanning electron micrograph (SEM) illustrating the surface conditions of the positive electrode active material layer of the positive electrode before rolling. FIG. 1 shows that the positive electrode active material does not form aggregates, and is present in dispersed state as mostly stand-alone primary particles. That is, in this Example, almost 100 wt % of the positive electrode active material is primary particles.

### (3) Negative Electrode Preparation

Mesophase spherules graphitized with a high temperature of 2800° C. (hereinafter referred to as “mesophase graphite”) was used as the negative electrode active material. A negative electrode material mixture slurry was prepared by mixing 100 parts by weight of this negative electrode active material, 2.5 parts by weight of modified SBR acrylic acid (product name: BM-400B, solid content of 40 wt %, manufactured by Zeon Corporation), 1 part by weight of carboxymethyl cellulose, and an appropriate amount of water with a double-armed kneader. This negative electrode material mixture slurry was applied on copper foil with a thickness of 10 μm, dried, rolled, and cut to give a predetermined size, to obtain a negative electrode.

### (4) Porous Film Preparation

A slurry containing 60 wt % of metal oxide particles was prepared by mixing 100 parts by weight of alumina (Al₂O₃, average particle size 0.2 μm), 4 parts by weight of a polyacrylic acid derivative (binder), and an appropriate amount of NMP as a dispersion medium with a non-media dispersing machine (product name: Clear Mix, manufactured by Mtechnique Co. Ltd.). This paste was applied on a positive electrode, and dried, to make a porous film with a thickness of 4 μm on both sides of the positive electrode surface.

### (5) Non-Aqueous Electrolyte Preparation

A non-aqueous electrolyte (liquid electrolyte) was obtained by adding vinylene carbonate to a solvent mixture of 1:3 volume ratio of ethylene carbonate and ethyl methyl carbonate, in an amount of 1 wt % relative to a total amount of the solvent mixture, and further dissolving LiPF₆ in the mixture so that the concentration of the LiPF₆ is 1.0 mol/L.

### (6) Cylindrical Battery Preparation

To a current collector of the predetermined positive electrode and a current collector of the predetermined negative electrode, an aluminum-made positive electrode lead, and a nickel-made negative electrode lead were attached, respectively. The positive electrode and the negative electrode were wound with a separator with a thickness of 20 μm, to form an electrode assembly. Insulating plates were disposed at an upper portion and a lower portion of the electrode assembly; the negative electrode lead was welded to a battery case, and the positive electrode lead was welded to the sealing plate with an internal pressure-activated safety valve; and the whole assembly was inserted into the battery case. Afterwards, 5.5 g of the non-aqueous electrolyte was injected into the battery case with a reduced-pressure method. Lastly, by crimping the opening end of the battery case to the sealing plate with the gasket interposed therebetween, 18650 type cylindrical battery A (diameter of 18 mm, height of 65 mm) was obtained. The obtained cylindrical battery had a battery capacity of 2000 mAh.

### EXAMPLE 2

Cylindrical battery B of the present invention was made in the same manner as Example 1, except that the porous film was formed on both sides of the negative electrode surface instead of the positive electrode.

### EXAMPLE 3

Cylindrical battery C of the present invention was made in the same manner as Example 1, except that the porous film was formed and disposed on one surface of the separator instead of the positive electrode, so as to allow the positive electrode to face the porous film on the separator surface when assembling the electrode assembly.

### EXAMPLE 4

Cylindrical battery D of the present invention was made in the same manner as Example 1, except that magnesia (MgO) was used instead of alumina as the metal oxide particles.

### COMPARATIVE EXAMPLE 1

Cylindrical battery E of Comparative Example 1 was made in the same manner as Example 1, except that the porous film was not formed on the positive electrode surface.

### COMPARATIVE EXAMPLE 2

Cylindrical battery F of Comparative Example 2 was made in the same manner as Example 1, except that in the positive electrode active material preparation, the positive electrode composite oxide and NMP were just mixed, without two hours of the crushing process with zirconia beads having a diameter of 2 mm in the planetary ball mill.

Scanning electron micrograph (SEM) of FIG. 2 shows the surface condition of the positive electrode active material layer in the positive electrode before rolling. It is clear from FIG. 2 that the positive electrode active material is present as the secondary particles which were formed as the aggregated and bonded primary particles. That is, in this Comparative Example, almost 100 wt % of the positive electrode active material is secondary particles.

### COMPARATIVE EXAMPLE 3

Cylindrical battery G of Comparative Example 3 was made in the same manner as Comparative Example 2, except that the porous film was not made on the positive electrode surface.

### (6) Battery Evaluation

### Initial Capacity

Cylindrical batteries A to G thus obtained were charged at a constant current of 200 mA to an upper limit voltage of 4.1 V, aged for a week at 40° C., and discharged at 200 mA to 3.0 V. Afterwards, the batteries were charged at a constant current of 1400 mA under an atmosphere of 25° C. to an upper limit voltage of 4.2 V, and charged at a constant voltage of 4.2 V to 100 mA. Then, the batteries were discharged at 1000 mA to 3.0 V: the discharge capacity at this point was regarded as initial capacity.

### Cycle Life Performance

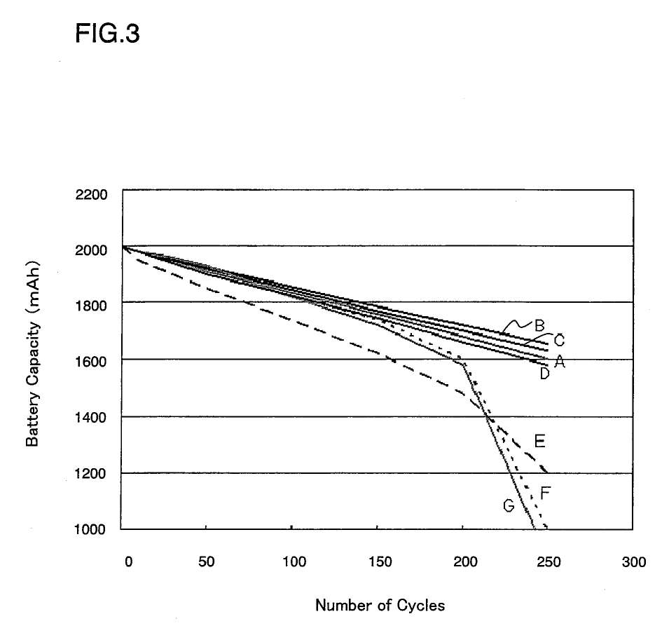

The following cycle was carried out for cylindrical batteries A to D of the present invention and comparative cylindrical batteries E to G: charging at a constant current under an atmosphere of 25° C. (at 1400 mA to an upper limit voltage of 4.2 V), charging at a constant voltage (at 4.2 V to 100 mA), and discharging (at 1000 mA to 3.0 V). The discharge capacity at the time of discharge was obtained, and regarded as battery capacity. This cycle was repeated, and battery capacity was determined for every cycle to check cycle life performance of each cylindrical battery. The results are shown in FIG. 3. FIG. 3 is a graph illustrating cycle life performance of cylindrical batteries A to G.

The following is clarified from FIG. 3. Cycle life performance of cylindrical batteries A to D of the present invention is more excellent than that of cylindrical batteries F and G of Comparative Examples 2 and 3. The following may be the reasons. In cylindrical batteries F and G of Comparative Examples 2 and 3, for the positive electrode active material, secondary particles of aggregated primary particles are used. When cylindrical batteries F and G are repeatedly cycled for charge and discharge, due to the expansion and contraction of primary particles, grain boundary stress is generated between primary particles to disintegrate secondary particles. Due to the disintegration, the primary particles that are present inside the disintegrated secondary particle are disconnected from and lose contact with the primary particles at the secondary particle surface, and since those primary particles are present inside the disintegrated secondary particle, those particles cannot have contact with the conductive agent. Therefore, the primary particles that are present inside the secondary particle do not contribute to charge and discharge reaction, and the battery capacity declines to the degree of the presence of such particles.

On the other hand, in cylindrical batteries A to D of the present invention, almost 100 wt % of the positive electrode active material is dispersed as primary particles, and even the primary particle aggregates having bonding strength weaker than that of the secondary particle are rarely generated. Therefore, even though primary particles are expanded and contracted by charge and discharge cycles, without presence of secondary particles, decline in battery capacity due to disintegration of the secondary particles is not caused.

In cylindrical battery E of Comparative Example 1, since the positive electrode active material is primary particles in dispersed state, compared with cylindrical batteries F and G of Comparative Examples 2 and 3, the degree of decline in battery capacity after 200 cycles of the charge and discharge cycle is low. However, since the porous film is not formed on the positive electrode surface, compared with cylindrical batteries A to D of the present invention, cycle life performance is clearly inferior. This is probably because with no porous film formed on the positive electrode surface in cylindrical battery E, metal ions leached from positive electrode active material deposited on the negative electrode active material surface, and caused decline in negative electrode capacity and battery capacity.

Since the same positive electrode active material as used in cylindrical battery E was used in cylindrical batteries A to D of the present invention as well, although the amount of the metal ions leached from the positive electrode active material is large, the porous film formed on the positive electrode, the negative electrode, or the separator surface captures the metal ions. Therefore, the metal ions are prevented from being deposited onto the negative electrode active material, decline in negative electrode capacity and battery capacity is curbed, and high-level cycle life performance is maintained. From comparison between cylindrical battery A and cylindrical battery D, it is clear that both alumina and magnesia are effective.

Cylindrical batteries F and G of Comparative Examples 2 and 3 both use the positive electrode active material of secondary particles. Cylindrical battery F and cylindrical battery G are different in that cylindrical battery F has the porous film, whereas cylindrical battery G has no porous film. However, cylindrical batteries F and G have almost the same level of cycle life performance. That is, although they have the same degree of battery capacity with cylindrical batteries F and G of the present invention up to about 150th cycle, battery capacity rapidly declines after the 150th cycle. Therefore, it is clear that in those batteries using the positive electrode active material of secondary particle powder, decline in battery capacity due to the disintegration of the secondary particles is more significant than decline in battery capacity due to the metal ions leached from the positive electrode active material. Although cycle life performance of cylindrical batteries is evaluated in the above Examples, the same effects can be obtained with the batteries having different form, such as prismatic battery, as long as the elements particular to the present invention are the same.

### EXAMPLE 5

A positive electrode material mixture slurry was made by mixing 1000 g of the positive electrode active material in which the secondary particles with the average particle size of 10 μm made in “positive electrode active material preparation” of Example 1 and the primary particles with the average particle size of 0.4 μm made by crushing the secondary particles with a planetary ball mill were mixed in a weight ratio of 20:80; 25 g of acetylene black; 400 g of an NMP solution dissolving 8 wt % polyvinylidene fluoride (PVDF)(binder); and 700 g of NMP (solvent). This positive electrode material mixture slurry was applied on both sides of Al foil with a thickness of 15 μm (positive electrode current collector), dried, rolled, and cut to give a predetermined size to obtain a positive electrode. Cylindrical battery H of the present invention was made in the same manner as Example 2, except that this positive electrode was used.

### COMPARATIVE EXAMPLE 4

A cylindrical battery I for comparison was made in the same manner as Example 5, except that the positive electrode was made by changing the proportion of the secondary particles with the average particle size of 10 μm to the primary particles with the average particle size of 0.4 μm, to 50:50 in weight ratio.

### Cycle Life Performance

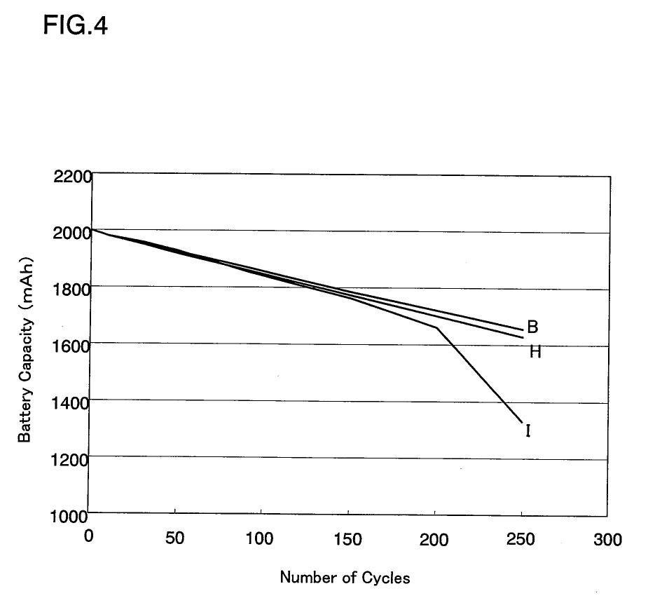

Cylindrical batteries B and H of the present invention, and cylindrical battery I for comparison were cycled by charging at a constant current under an atmosphere of 25° C. (at 1400 mA to an upper limit voltage of 4.2 V), charging at a constant voltage (at 4.2 V to 100 mA), and discharging (at 1000 mA to 3.0 V). The discharge capacity at the time of discharge was obtained and regarded as battery capacity. Such a cycle was repeated, and battery capacity for every cycle was determined, to check cycle life performance of each cylindrical battery. The results are shown in FIG. 4. FIG. 4 is a graph illustrating cycle life performance of cylindrical batteries B, H, and I.

Cylindrical battery B of the present invention used the positive electrode active material of almost 100 wt % primary particles, and the porous film for capturing the metal ions leached from the positive electrode active material is provided. Cylindrical battery H of the present invention uses the positive electrode active material containing 80 wt % of the primary particles and 20 wt % of the secondary particles, and the porous film for capturing the metal ions leached from the positive electrode active material is provided. On the other hand, cylindrical battery I for comparison used the positive electrode active material containing 50 wt % of the primary particles and 50 wt % of the secondary particles, and the porous film for capturing the metal ions leached from the positive electrode active material is provided.

From FIG. 4, it is clear that cylindrical battery H of the present invention has almost the same level of cycle performance as that of cylindrical battery B of the present invention. On the other hand, in cylindrical battery I for comparison, cycle performance clearly declined compared with cylindrical battery H of the present invention. This clarifies that by using the positive electrode active material with 80 wt % primary particles, improvement in cycle performance can be achieved.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A non-aqueous electrolyte secondary battery comprising:
an electrode assembly comprising:
a positive electrode containing a positive electrode active material capable of absorbing and desorbing lithium ions,
a negative electrode containing a negative electrode active material capable of absorbing and desorbing lithium ions, and
a separator interposed between said positive electrode and said negative electrode; and
a non-aqueous electrolyte retained by said electrode assembly,
wherein 80 wt % or more of said positive electrode active material is primary particles, and
at least a portion of said separator comprises a porous film.

2. The non-aqueous electrolyte secondary battery in accordance with claim 1, wherein said porous film includes metal oxide particles.

3. The non-aqueous electrolyte secondary battery in accordance with claim 2, wherein said metal oxide particles are at least one selected from the group consisting of a magnesium oxide, an aluminum oxide, and a zirconium oxide.

4. The non-aqueous electrolyte secondary battery in accordance with claim 1, wherein the average particle size of said primary particles is 0.1 to 10 μm.

5. The non-aqueous electrolyte secondary battery in accordance with claim 1, wherein the average particle size of said primary particles is 0.1 to 3 μm.

6. The non-aqueous electrolyte secondary battery in accordance with claim 1, wherein said positive electrode active material is a lithium-containing composite metal oxide represented by the general formula:
LiₓCo_{y}M_{1-y}O_{z}
where M is at least one element selected from the group consisting of Na, Mg, Sc, Y, Mn, Fe, Co, Ni, Cu, Zn, Al, Cr, Pb, Sb, and B; and x=0 to 1.2, y=0 to 0.9, and z=2.0 to 2.3.
